(19) United States
(12) Patent Application Publication
(10) Pub. No.: US 2022/0335857 A1
(43) Pub. Date: Oct. 20, 2022

(54) System and Method of Managing a Lottery Service for Visually-Impaired Users

(71) Applicant: NPC Advanced Tech LLC, Sacramento, CA (US)

(72) Inventor: Nicholas Patrick Clark, Sacramento, CA (US)

(21) Appl. No.: 17/677,848

(22) Filed: Feb. 22, 2022

Related U.S. Application Data
(60) Provisional application No. 63/175,452, filed on Apr. 15, 2021.

(51) Int. Cl. G09B 21/00; G07F 17/32

(52) U.S. Cl. CPC G09B 21/005; G09B 21/006; G09B 21/008; G07F 17/329; G07F 17/3237

(57) ABSTRACT

A system and a method of managing a lottery service for visually-impaired users allow users to read a lottery ticket with a plurality of braille-inscribed ticket numbers. The system includes a PC device, at least one remote server, at least one physical lottery ticket, and at least one external server. The method begins by scanning the braille-inscribed ticket numbers off the physical lottery ticket with the PC device. The braille-inscribed numbers are converted into a plurality of digital ticket numbers with the PC device. The digital ticket numbers are relayed from the PC device to the remote server. A plurality of winning numbers is then received for the lottery service from the external server with the remote server. If the digital ticket numbers match the plurality of winning numbers, a lottery winning notification is generated with the remote server and is then outputted with the PC device.

The current application claims a priority to the U.S. provisional patent application Ser. No. 63/175,452 filed on Apr. 15, 2021.

### FIELD OF THE INVENTION

The present invention generally relates to playing tools for lottery games. More specifically, the present invention is a system and method of managing a lottery service for visually impaired users.

### BACKGROUND OF THE INVENTION

Over 285 million people within the world are visually impaired with an expected growth within the next 30 years. Being visually impaired can range from being completely blind to not being able to see objects clearly even with the aid of various prescription glasses. Many visually impaired people are able to perform and participate in all the same tasks as an individual without a visual disability. Gambling and playing the lottery is a popular pastime that many people love to participate in with the hope that one day that they could hit the lucky numbers and win the jackpot prize.

Unfortunately, with how lottery tickets are designed the inclusivity for visually impaired people is limited due to the small numbers on the ticket. One current solution for dealing with this is by having the user use a computer that is equipped with assistive technology such as a braille display. This allows the user to use braille to read the numbers however they need to invest in both a computer and expensive technology in order to use the braille to read the numbers. Unfortunately, not all individuals can afford such assistive technology and are then left out of the opportunity to participate.

An objective of the present invention is to provide users with braille lottery tickets, to ensure that visually impaired individuals can participate in playing the lottery and other games. The present invention intends to provide users with a phone application that works in tandem with the braille lottery tickets to ensure that other individuals that cannot read braille but can still know what the numbers on their lottery ticket are. In order to accomplish that, a preferred embodiment of the present invention comprises a lottery ticket and a phone application. Further, the lottery ticket is equipped with braille for the visually impaired. Thus, the present invention is a lottery ticket designed with braille numbers with a phone application to allow for visually impaired individuals to better see or understand what numbers they received on their lottery tickets and to know if they have won a prize.

### BRIEF DESCRIPTION OF THE DRAWINGS

FIG. 1 is a block diagram of a system used to implement a method for the overall process of the present invention.

FIG. 2 is a flowchart illustrating the overall process for the method of the present invention.

FIG. 3 is a flowchart illustrating the subprocess of delivering a physical lottery ticket to a user physical address.

FIG. 4 is a flowchart illustrating the subprocess of requiring a user age and a current location in order to determine the eligibility of receiving a physical lottery ticket.

FIG. 5 is a flowchart illustrating the subprocess of audibly outputting each digital ticket number of a plurality of digital ticket numbers with a speaker of a corresponding personal computing (PC) device.

FIG. 6 is a flowchart illustrating the subprocess of enlarging each digital ticket number as the plurality of digital ticket numbers is displayed with the corresponding PC device.

FIG. 7 is a flowchart illustrating the subprocess of identifying at least one specific braille-inscribed ticket number from a plurality of braille-inscribed ticket numbers with a special status.

FIG. 8 is a flowchart illustrating a continuation of the overall process for the method of the present invention.

FIG. 9 is a flowchart illustrating the subprocess of providing a user account with a piece of information that corresponds to at least one information request.

FIG. 10 is a flowchart illustrating the subprocess of broadcasting the piece of information before the piece of information is available for the corresponding PC device.

### DETAIL DESCRIPTIONS OF THE INVENTION

All illustrations of the drawings are for the purpose of describing selected versions of the present invention and are not intended to limit the scope of the present invention.

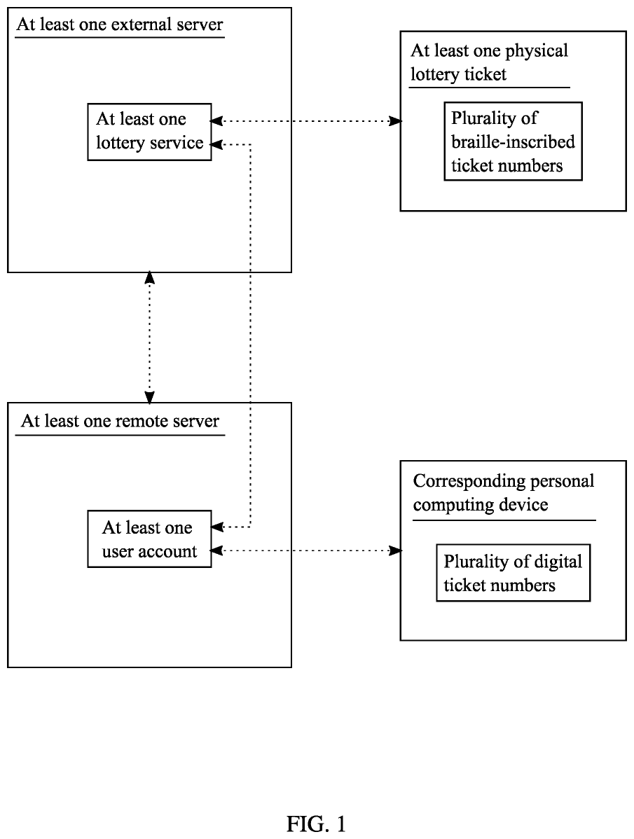

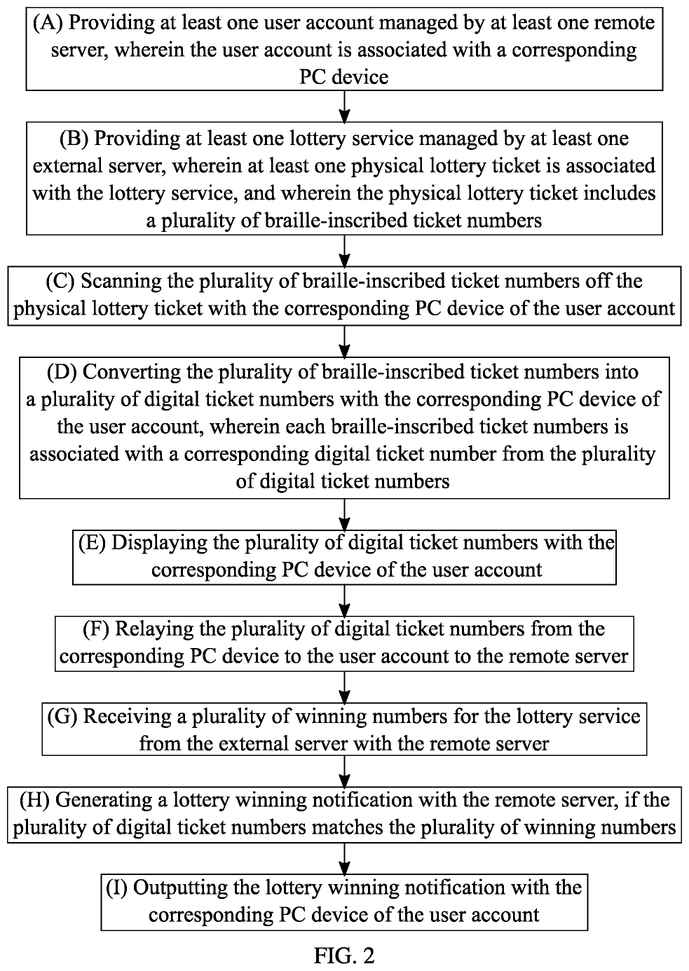

The present invention is a system and method of managing a lottery service for visually-impaired users. The present invention provides an application that is capable of scanning a lottery ticket catered for visually-impaired users. Visually-impaired users utilizing the present invention either prefer or require braille in order to read. More specifically, visually-impaired users may be partially blind, be blind, have a high-grade vision prescription, and so on. The present invention reduces the burden of visually-impaired people to play a lottery game and determines if a visually-impaired person with a lottery ticket has won or lost. In order for a visually-impaired person to easily play in a lottery game, the physical system used to implement the method for the present invention includes a personal computing (PC) device and at least one remote server (Step A), seen in FIG. 1 and FIG. 2. The PC device is preferably a smartphone but can also be, but is not limited to, a desktop, a tablet PC, a smartwatch, and a laptop. In order for a user manage the wins and losses of a visually-impaired user and provide the visually-impaired user with lottery game-related details, at least one user account is managed by the at least one remote server, wherein the user account is associated with the corresponding PC device. The at least one user account is associated with and utilized by a user that is visually-impaired. The at least one user account may store and organize any information scanned by the user with the corresponding PC device. The physical system further includes at least one physical lottery ticket and at least one external server (Step B), also seen in FIG. 1 and FIG. 2. The at least one physical lottery ticket serves as a physical ticket that a visually-impaired person may read. The at least one external server manages a lottery game and tracks the participants of the lottery game. The at least one external server determines and stores winning lottery numbers for each game. More specifically, at least one lottery service is managed by the at least one external server. The at least one lottery service is a lottery game such as the Powerball or Mega millions. Moreover, the at least one physical lottery ticket is associated with the lottery service, and the physically lottery ticket includes a plurality of braille-inscribed ticket numbers. The at least one physical lottery ticket is a physical ticket that provides each user with a unique set of lottery numbers that may win a jackpot, may win prizes, and not win at all. The plurality of braille-inscribed numbers allows a visually-impaired user to read lottery numbers by physically touching the at least one physical lottery ticket.

The overall process for the method of the present invention includes the following steps that are implemented with the PC device, the at least one remoter server, the at least one physical lottery ticket, and the at least one external server, seen in FIG. 1 and FIG. 2. In order to register the plurality of braille-inscribed ticket numbers with the user account, the method begins by scanning the plurality of braille-inscribed ticket numbers off the physical lottery ticket with the corresponding PC device of the user account (Step C), as seen in FIG. 2. In order for the plurality of braille-inscribed ticket numbers to be processed by the at least one remote server, the plurality of braille-inscribed ticket numbers is converted into a plurality of digital ticket numbers with the corresponding PC device of the user account, wherein each braille-inscribed ticket numbers is associated with a corresponding digital ticket number from the plurality of digital ticket numbers (Step D), thereby providing the correct amount of lottery ticket numbers per at least one physical lottery ticket. The plurality of digital ticket numbers is a virtual representation of the lottery numbers that are braille-inscribed on the physical lottery ticket. The plurality of digital ticket numbers is displayed with the corresponding PC device of the user account (Step E), which allows the user account to view the plurality of braille-inscribed ticket numbers on an electronic screen instead of the physical lottery ticket itself In order to determine if the plurality of braille-inscribed ticket numbers is considered winning numbers or losing numbers, the plurality of digital ticket numbers is relayed from the corresponding PC device to the user account to the remote server (Step F). A plurality of winning numbers is received for the lottery service from the external server with the remote server (Step G), thereby providing the remote server with the necessary information to determine a winner. Moreover, the plurality of winning numbers is a set of winning numbers of a drawing for at least one lottery service. In order for a visually-impaired user to be made aware that the plurality of braille-inscribed ticket numbers is a winning set, a lottery winning notification is generated with the remote server, if the plurality of digital ticket numbers matches the plurality of winning numbers (Step H). The lottery winning notification can be, but is not limited to, a visual message, a visual distinction between the plurality of winning numbers and the plurality of digital ticket numbers, or an audible message. More specifically, the visual distinction may be, but not be limited to, color-coded numbers or highlighted numbers that indicate each digital ticket number as winning or losing. The visually-impaired user receives the lottery winning notification as the lottery winning notification is outputted with the corresponding PC device of the user account (Step I).

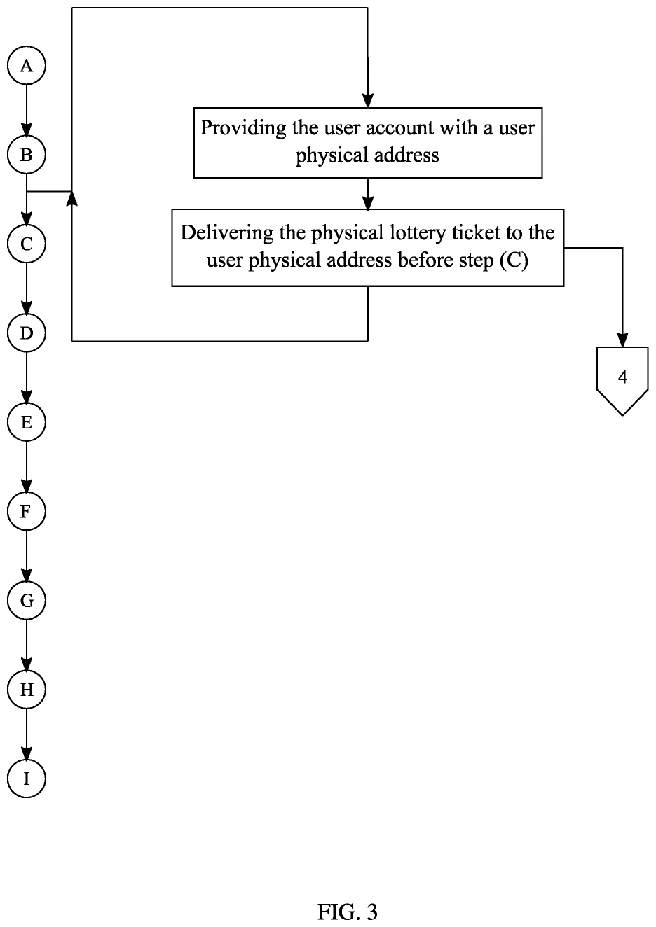

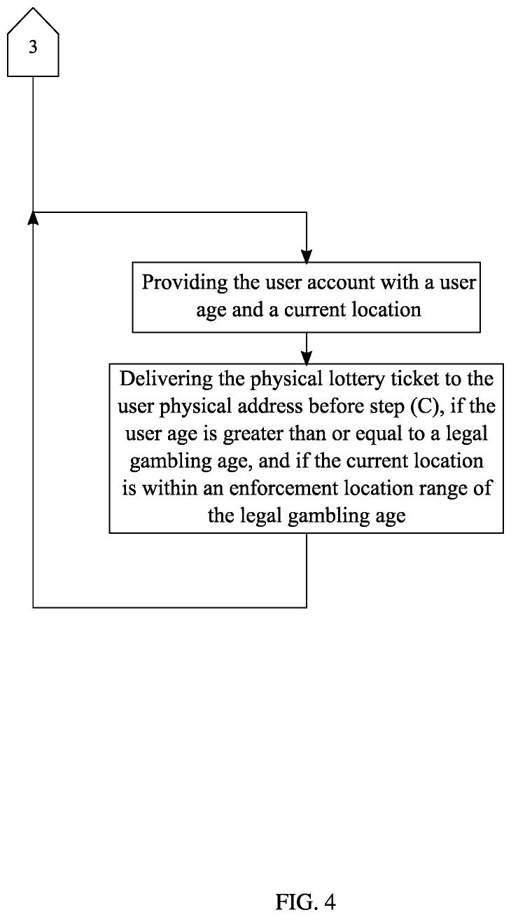

In order to receive at least one physical lottery ticket at specific location, preferably at home, the user account includes a user physical address, seen in FIG. 3. The user physical address identifies a delivery address for the user account so that a visually-impaired user does not need to travel in order to retrieve at least one physical lottery ticket with a plurality of braille-inscribed numbers. The user physical address is associated with the user account as the visually-impaired user inputs the user physical address into the user account with the corresponding PC device. In order for the physical lottery ticket to be scanned with the corresponding PC device, the physical lottery ticket is delivered to the user physical address before Step C. Furthermore, in order to guarantee the eligibility for the user account to receive at least one physical lottery ticket, the user account further includes a user age and a current location, seen in FIG. 4. The user age is the current age of the visually-impaired user, and the current location is a real-time location of the visually-impaired user. Similarly, in order to associate the user age and the current location with the user account, the visually-impaired user inputs the user age and the current location into the user account with the corresponding PC device. In order to determine if the at least one physical lottery ticket is deliverable to the visually-impaired user, the physical lottery ticket is delivered to the user physical address before Step C, if the user age is greater than or equal to a legal gambling age, and if the current location is within an enforcement location range of the legal gambling age. The legal gambling age is an age minimum that the user age must be in order to legally purchase or receive the physical lottery ticket. The legal gambling age is designated by a corresponding government to the current location. The enforcement location range is a maximum range between a pickup location for the physical lottery ticket, such as a gas station convenient store, and the current location of the visually-impaired user.

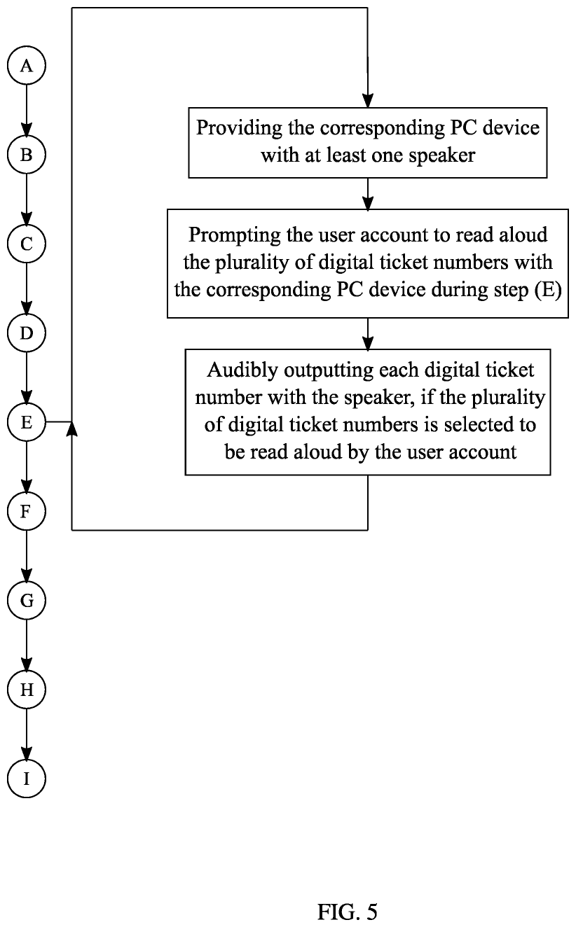

In order to audibly output the plurality of digital ticket numbers, the corresponding PC device includes at least one speaker, seen in FIG. 5. The at least one speaker audibly outputs any messages or sounds that a visually-impaired user may readily receive and interpret. Furthermore, the at least one speaker reduces any stress for the visually-impaired user associated with reviewing the display screen of the corresponding PC device. In order for a visually-impaired user to request the plurality of digital ticket numbers to be audibly outputted, the user account is prompted to read aloud the plurality of digital ticket numbers with the corresponding PC device during Step E. Each digital ticket number is audibly outputted with the speaker, if the plurality of digital ticket numbers is selected to be read aloud by the user account, thereby alerting the visually-impaired user of each number from the plurality of digital ticket numbers.

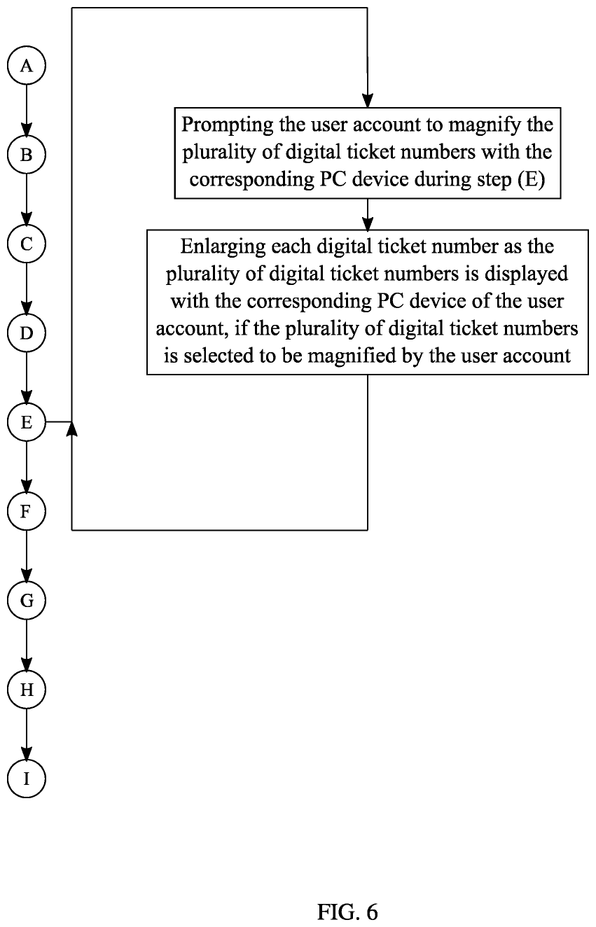

If a visually-impaired user wishes to read or review the plurality of digital ticket numbers with the display screen of the corresponding PC device, the present invention facilitates the reading of the plurality of digital ticket numbers as the user account is prompted to magnify the plurality of digital ticket numbers with the corresponding PC device during Step E, as seen in FIG. 6. In order for a visually-impaired user to be able to readily view each digital ticket number, each digital ticket number is enlarged as the plurality of digital ticket numbers is displayed with the corresponding PC device of the user account, if the plurality of digital ticket numbers is selected to be magnified by the user account. The enlargement of the plurality of digital ticket numbers significantly magnifies each number from the plurality of digital ticket numbers, thereby reducing the stress for the eyes of the visually-impaired user while viewing the display screen of the corresponding PC device.

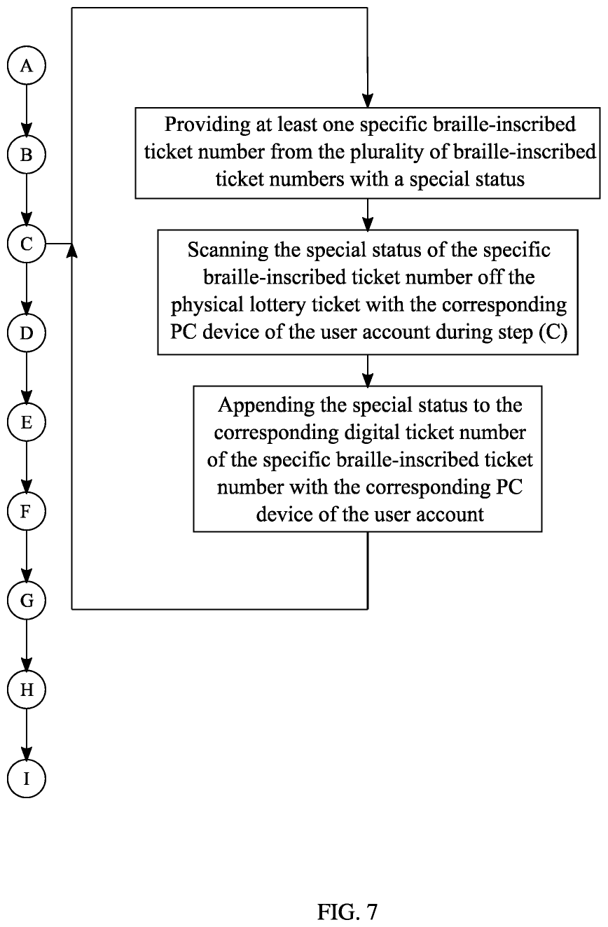

As the lottery service includes a special number that is required to win a jackpot or may provide a prize for a player, a bonus ticket number is distinguishable among the plurality of braille-inscribed ticket numbers as at least one specific braille-inscribed ticket number is included from the plurality of braille-inscribed ticket numbers with a special status, as seen in FIG. 7. For example, a Powerball number or a Mega number corresponds to the special status of the at least one specific braille-inscribed ticket numbers depending on the corresponding lottery service. In order for the visually-impaired user to determine which of the plurality of braille-inscribed ticket numbers is the specific braille-inscribed ticket number, the specific braille-inscribed ticket number is encircled by a raised ring. The raised ring physically separates the specific braille-inscribed ticket number from the remaining braille-inscribed ticket numbers. The physical lottery ticket is fully reviewed and compared as the special status of the specific braille-inscribed ticket number is scanned off the physical lottery ticket with the corresponding PC device of the user account during Step C. Moreover, the special status is appended to the corresponding digital ticket number of the specific braille-inscribed ticket number with the corresponding PC device of the user account, providing a complete set of information associated with the physical lottery ticket.

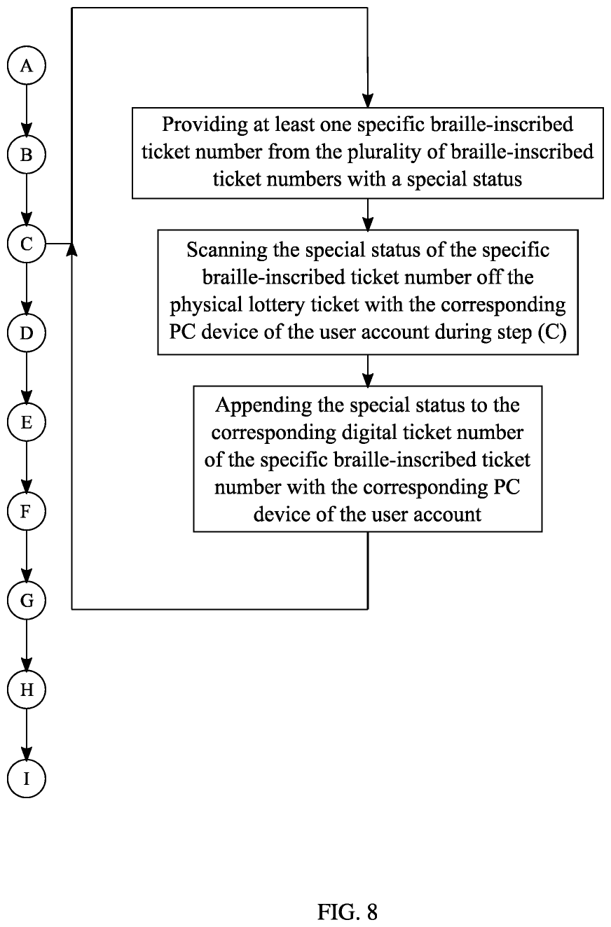

In order to access specific information regarding a specific game or multiple games of a lottery service, at least one piece of information related to the lottery service is received from the external server with the remote server (Step J), seen in FIG. 8. The at least one piece of information is designated information associated with a lottery service. The designated information can be, but is not limited to, a list of previous winners and each corresponding winning amount, the date of game associated with each previous winner, a listing of at least one latest winner and the winning amount, daily winning numbers, past winning numbers and the corresponding dates of each game, current jackpot winning amounts, upcoming jackpot winning amounts, current fast play progressive top prizes, upcoming jackpot fast play progressive top prizes, breakdowns of winning amounts or winning prizes, plurality of digital ticket numbers of a physical lottery ticket that has been previously scanned, or combinations thereof In order for the corresponding PC device to receive the piece of information, the piece of information is relayed from the remote server to the corresponding PC device of the user account (Step K). The visually-impaired user is able to review the piece of information as the piece of information is outputted with the corresponding PC device of the user account (Step L).

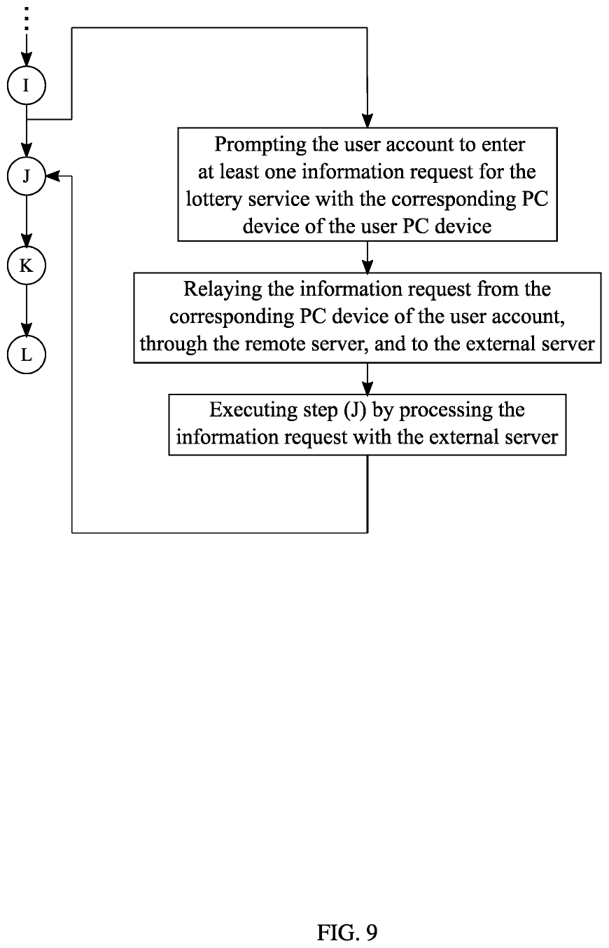

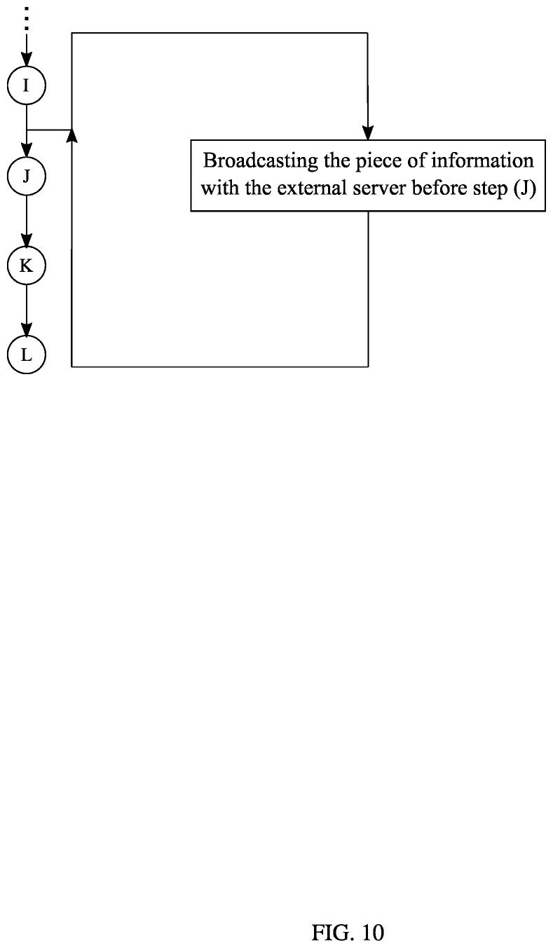

In order to review a specific piece of information, the user account is prompted to enter at least one information request for the lottery service with the corresponding PC device of the user PC device, as seen in FIG. 9. The at least one information request identifies the information desired by the visually-impaired user. In order to retrieve only the specific piece of information, the information request is relayed from the corresponding PC device of the user account, through the remote server, and to the external server. In order to display only the specific piece of information, Step J is executed by processing the information request with the external server. Alternatively, in order to provide the user account with up-to-date and accurate information, the piece of information is broadcasted with the external server before Step J, as seen in FIG. 10. For example, the plurality of winning numbers is designated and then made available for viewing and comparison.

Although the invention has been explained in relation to its preferred embodiment, it is to be understood that many other possible modifications and variations can be made without departing from the spirit and scope of the invention as hereinafter claimed.

What is claimed is:

1. A method of managing a lottery service for visually-impaired users, the method comprising the steps of:
(A) providing at least one user account managed by at least one remote server, wherein the user account is associated with a corresponding personal computing (PC) device;
(B) providing at least one lottery service managed by at least one external server, wherein at least one physical lottery ticket is associated with the lottery service, and wherein the physical lottery ticket includes a plurality of braille-inscribed ticket numbers;
(C) scanning the plurality of braille-inscribed ticket numbers off the physical lottery ticket with the corresponding PC device of the user account;
(D) converting the plurality of braille-inscribed ticket numbers into a plurality of digital ticket numbers with the corresponding PC device of the user account, wherein each braille-inscribed ticket numbers is associated with a corresponding digital ticket number from the plurality of digital ticket numbers;
(E) displaying the plurality of digital ticket numbers with the corresponding PC device of the user account;
(F) relaying the plurality of digital ticket numbers from the corresponding PC device to the user account to the remote server;
(G) receiving a plurality of winning numbers for the lottery service from the external server with the remote server;
(H) generating a lottery winning notification with the remote server, if the plurality of digital ticket numbers matches the plurality of winning numbers; and
(I) outputting the lottery winning notification with the corresponding PC device of the user account.

2. The method of managing a lottery service for visually-impaired users, the method as claimed in claim 1 comprising the steps of:
providing the user account with a user physical address; and
delivering the physical lottery ticket to the user physical address before step (C).

3. The method of managing a lottery service for visually-impaired users, the method as claimed in claim 2 comprising the steps of:
providing the user account with a user age and a current location; and
delivering the physical lottery ticket to the user physical address before step (C), if the user age is greater than or equal to a legal gambling age, and if the current location is within an enforcement location range of the legal gambling age.

4. The method of managing a lottery service for visually-impaired users, the method as claimed in claim 1 comprising the steps of:
providing the corresponding PC device with at least one speaker;
prompting the user account to read aloud the plurality of digital ticket numbers with the corresponding PC device during step (E); and
audibly outputting each digital ticket number with the speaker, if the plurality of digital ticket numbers is selected to be read aloud by the user account.

5. The method of managing a lottery service for visually-impaired users, the method as claimed in claim 1 comprising the steps of:
prompting the user account to magnify the plurality of digital ticket numbers with the corresponding PC device during step (E); and
enlarging each digital ticket number as the plurality of digital ticket numbers is displayed with the corresponding PC device of the user account, if the plurality of digital ticket numbers is selected to be magnified by the user account.

6. The method of managing a lottery service for visually-impaired users, the method as claimed in claim 1 comprising the steps of:
providing at least one specific braille-inscribed ticket number from the plurality of braille-inscribed ticket numbers with a special status;
scanning the special status of the specific braille-inscribed ticket number off the physical lottery ticket with the corresponding PC device of the user account during step (C); and
appending the special status to the corresponding digital ticket number of the specific braille-inscribed ticket number with the corresponding PC device of the user account.

7. The method of managing a lottery service for visually-impaired users, the method as claimed in claim 6, wherein the specific braille-inscribed ticket number is encircled by a raised ring.

8. The method of managing a lottery service for visually-impaired users, the method as claimed in claim 1 comprising the steps of:
(J) receiving at least one piece of information related to the lottery service from the external server with the remote server;
(K) relaying the piece of information from the remote server to the corresponding PC device of the user account; and
(L) outputting the piece of information with the corresponding PC device of the user account.

9. The method of managing a lottery service for visually-impaired users, the method as claimed in claim 8 comprising the steps of:
prompting the user account to enter at least one information request for the lottery service with the corresponding PC device of the user PC device;
relaying the information request from the corresponding PC device of the user account, through the remote server, and to the external server; and
executing step (J) by processing the information request with the external server.

10. The method of managing a lottery service for visually-impaired users, the method as claimed in claim 8 comprising the step of:
broadcasting the piece of information with the external server before step (J)
